(19) United States
(12) Patent Application Publication
(10) Pub. No.: US 2007/0283239 A1
(43) Pub. Date: Dec. 6, 2007

(54) Methods, systems, and computer program products for providing a user interaction model for use by a device

(76) Inventor: Robert Paul Morris, Raleigh, NC (US)

Correspondence Address: SCENERA RESEARCH, LLC;JENKINS, WILSON & TAYLOR, P.A., 3100 TOWER BLVD, SUITE 1400, DURHAM, NC, 27707, US

(21) Appl. No.: 11/443,546

(22) Filed: May 30, 2006

(51) Int. Cl. G06F 17/00

(52) U.S. Cl. 715/511

(57) ABSTRACT

Methods, systems, and computer program products for providing a user interaction model for use by a device to match the capabilities of a display connected to the device or an input interface used by the device are disclosed. According to one aspect, an indication to use at least one of a display and an input interface usable by a device is received. Further, a characteristic of at least one of the display and the input interface is detected. A user interaction model may be determined from a plurality of user interaction models based on the characteristic. Further, the user interaction model may be activated for use with one of the connected display and the input interface.

### TECHNICAL FIELD

The subject matter described herein relates to matching the capabilities of a device to a display or input device. More particularly, the subject matter described herein relates to methods, systems, and computer program products for providing a user interaction model for use by a device to match the capabilities of a display connected to the device or an input interface used by the device.

### BACKGROUND

Many electronic devices include a built-in display and/or input interface. For example, personal digital assistants (PDAs), digital cameras, and mobile phones may include integrated displays and keypads. Electronic devices may also be operable to support external displays and input interfaces. These external components may have different characteristics than the built-in display and/or input interface of the device.

Some electronic devices using an alternate external display simply display the same type of display on the external display that would be displayed on the default display. Further, some electronic devices determine a size of an external display and may alter the layout and/or resolution of the external display or display additional information. These existing processes may result in an inefficient use of display space.

It would be beneficial to provide techniques for improving the use of external displays and input interfaces. For example, it would be beneficial to provide techniques for better utilizing a display to present information and graphics from a device. Further, it would be beneficial to better utilize the functionality of an external input interface by a device. For example, if a mobile phone is connected to an external television monitor, it may be desirable to change the way that the user can navigate and access mobile phone resources to better suit the type of interface. In this example, it may be desirable to provide an interface where resources can be accessed via the television remote control. However, as described above, conventional external display functions on electronic devices typically only re-size the displayed resources for display on the external display and do not change the way a user interacts with the displayed resources.

Accordingly, in light of the above described difficulties and needs associated with existing electronic devices and their external displays and input interfaces, there exists a need for improved methods, systems, and computer program products for providing matching the device with the capabilities of a display connected to the device or an input interface used by the device.

### SUMMARY

According to one aspect, the subject matter described herein includes methods, systems, and computer program products for providing a user interaction model for use by a device to match the capabilities of a display connected to the device or an input interface used by the device. One method receives an indication to use at least one of a display and an input interface usable by a device. A characteristic of at least one of the display and the input interface is detected. A user interaction model may be determined from a plurality of user interaction models based on the characteristic. Further, the user interaction model may be activated for use with one of the connected display and the input interface.

As used herein, a user interaction model is a representation of how an end user(s) interacts with a computer program or another device and also how the system responds. For example, a user interaction model may define the type of input used to access resources, the resolution and placement of resources on a display, colors to display resources, display layout, display size, display dot pitch, user interface navigation systems, and the like. The user interaction model may also include a user interface metaphor that ties everything together for the user. A metaphor defines the perspective that is presented to the user and the symbolic representation of the perspective. Exemplary metaphor symbolic representations include desktop metaphors, workspace metaphor, file cabinet metaphor, stack or card deck metaphor, writing pad or tablet metaphor, command line metaphor, wireless application protocol user interface (WAP UI) phone metaphor, TV/remote control metaphor, map metaphors, and the like. Exemplary metaphor perspective models include: domain models, which define the objects that a user can view, access, and manipulate through the user interface; task models, which describe the tasks an end user performs and dictate what interaction capabilities must be designed; user models, which represent the different characteristics of end users and the roles they are playing within the organization; platform models, which model the physical devices that are intended to host the application and how they interact with each other; dialogue models, which define how users can interact with the objects presentation (as push buttons, commands, etc.), with interaction media (as voice input, touch screen, etc), and the reactions that the user interface communicates via these objects; presentation models, which define application appearance, representation of the visual, haptic, and auditory elements that the user interface offers to its users; and application models, which define commands and data an application provides. Elements of a user interaction model are not exclusive in that a user interaction model may use one or more perspective models and one or more symbolic representation models. For example, MICROSOFT WINDOWS™ uses both a task model and user model in a desktop metaphor.

The subject matter described herein may be implemented using a computer program product comprising computer executable instructions embodied in a computer-readable medium. Exemplary computer-readable media suitable for implementing the subject matter described herein include chip memory devices, disk memory devices, programmable logic devices, application specific integrated circuits, and downloadable electrical signals. In addition, a computer-readable medium that implements the subject matter described herein may be distributed as represented by multiple physical devices and/or computing platforms.

### BRIEF DESCRIPTION OF THE DRAWINGS

Preferred embodiments of the subject matter described herein will now be explained with reference to the accompanying drawings of which:

FIG. 1 is a block diagram of an exemplary system comprising a device, a display, and an input interface according to an embodiment of the subject matter described herein;

FIG. 2 is a flow chart of an exemplary process for providing a user interaction model for use by a device to match the capabilities of a display connected to the device or an input interface used by the device according to an embodiment of the subject matter described herein;

FIG. 3 is a block diagram of an exemplary system for providing a user interaction model for use by a device to match the capabilities of a display connected to the device or an input interface used by the device according to an embodiment of the subject matter described herein;

FIG. 4 is a block diagram of an exemplary application according to the subject matter described herein;

FIG. 5 is a flow chart illustrating an exemplary process for providing a user interaction model for use by a device shown in FIG. 1 to match the capabilities of a display connected to the device or an input interface used by the device according to an embodiment of the subject matter described herein;

FIG. 6 is a flow chart of an exemplary process for use by the application shown in FIG. 4 for selecting a user interaction model according to an embodiment of the subject matter described herein; and

FIG. 7 is a flow chart of a process for using a user-related characteristic for determining a user interaction model for use by a device according to an embodiment of the subject matter described herein.

### DETAILED DESCRIPTION

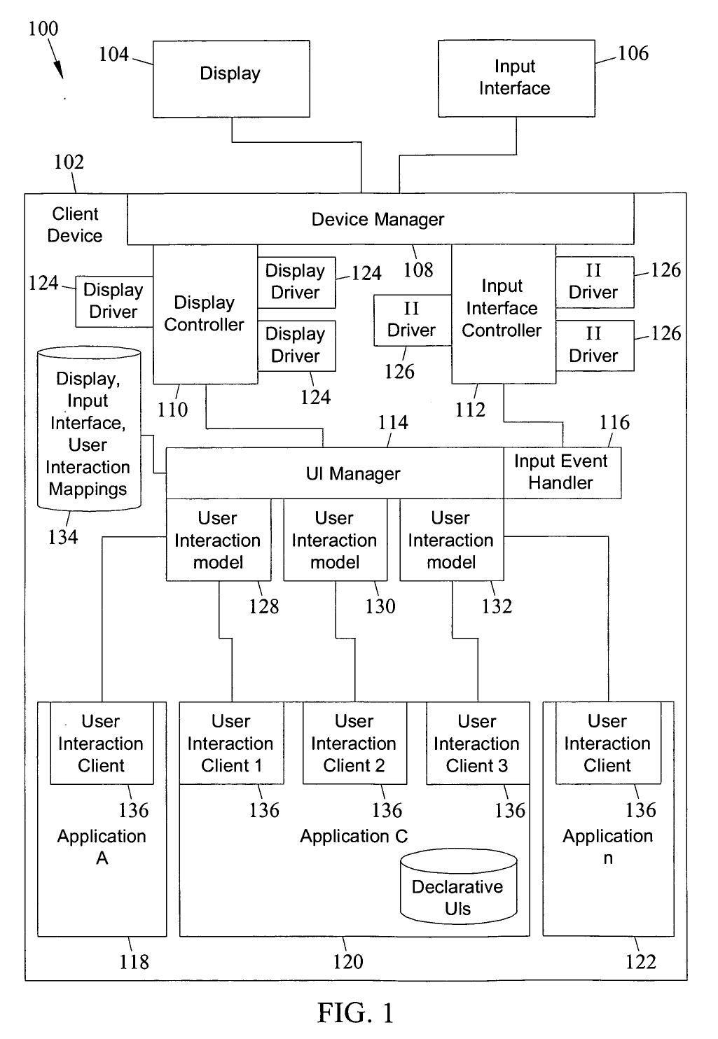

The subject matter described herein includes methods, systems, and computer program products for providing a user interaction model for use by a device to match the capabilities of a display connected to the device or an input interface used by the device. According to one aspect, a system according to the subject matter described herein may be implemented as hardware, software, and/or firmware components executing on one or more components of a system connectable to one or more displays and/or one or more input interfaces. FIG. 1 is a block diagram of an exemplary system 100 comprising a device 102, a display 104, and an input interface 106 according to an embodiment of the subject matter described herein. Device 102 may be any suitable system, such as a personal computer, a mobile phone, a PDA, a digital camera, and the like, for connecting to a display and/or an input interface. Display 104 may be any suitable interface for displaying graphical images and/or text. For example, display 104 may be a projector, a television (such as a cathode ray tube (CRT) television, a plasma television, and a high definition television (HDTV)), a monitor, a mobile phone display, a windows model display, and a remote display of a computer system. A user may input data via input interface 106. For example, input interface 104 may be a keyboard, a keypad, a touch screen interface, a tablet PC interface, or a mouse.

Device 102 may include a device manager 108, a display controller 110, an input interface controller 112, a user interaction manager 114, an input event handler 116, and a plurality of applications 118, 120, and 122. In one embodiment, device manager 108 may manage and monitor display drivers for one or more displays. For example, device manager 108 may manage and monitor a display driver for display 104. Further, device manager 108 may manage and monitor input interface drivers for one or more input interfaces. For example, device manager 108 may manage and monitor an input interface driver for input interface 106.

In order to use a user interaction model, an application may provide a user interaction client that drives the user interaction model. If an application does not support a user interaction model, the application may not be able to operate when a device is using a non-supported user interaction model. In one embodiment, a declarative language, such as an extended markup language (XML)-based user interface language (XUL), a transaction authority markup language (XAML), or an extensible hypertext markup language (XHTML), may be used to provide markup files associated with an application providing a user interface adhering to a user interaction model. An application may support more than one user interaction model and thus may be associated with one or more sets of files, with each set supporting a user interaction model. The file sets may intersect. In order to use a declarative user interaction language, a user interaction manager may support user interaction models 128 which parse and present the declared user interfaces associated with user interaction models supported by user interaction models 128.

In one embodiment, display controller 110 may provide a single interface through which device manager 108 handles displays. For example, displays may register a plurality of display drivers 124 with display controller 110. Display drivers 124 may be installed at any suitable time, such as when a new display is detected. The driver may be provided by the display, pre-stored on device 102, or retrievable from a server on demand. Each display driver 124 may be operable to provide display controller 110 with characteristics of the display being driven. Exemplary display characteristics include a size of a display, a resolution of a display, colors supported by a display, a number of colors supported by a display, a dot pitch of a display, a video format, and a display standard. Exemplary video formats include NTSC, DVI, DTV, MPEG, composite video, S-video, component video, etc. Exemplary display standards include MDA, Hercules, CGA, EGA, QVGA, VGA, MCGA, SVGA, 8514, XGA, WXGA, SXGA, WSXGA Wide XGA+, WSXGA, WXGA+, UXGA, WUXGA, QXGA, WQXGA, QSXGA, WQSXGA, QUXGA, WQUXGA, HXGA, WHXGA, HSXGA, WHSXGA, HUXGA, WHUXGA, and the like.

Input interface controller 112 may provide a single interface through which device manager 108 handles input interfaces. Input interface controller 112 may manage input interfaces. Exemplary input interfaces include a mouse, a keyboard, device buttons, a switch, a touchpad, and a remote control. Input interfaces may register a plurality of input interface drivers 126 with input interface controller 112. Input interface drivers 126 may be installed at any suitable time, such as installation upon detection of a new input interface. The input interface may be provided by the input interface, pre-stored on device 102, or retrievable from a server on demand. Each input interface 126 may be able to provide input interface controller 112 with characteristics of the input interface being driven.

User interaction manager 114 may be operable to communicate with display drivers 124 and input interface drivers 126 via an interface provided by display controller 110 and input interface controller 112, respectively. Further, user interaction manager 114 may perform basic operations, such as render characters, draw lines, draw various shapes, and color designated areas of an image.

Device 102 may include user interaction models 128,130, and 132. A user interaction model may be driven by a user interaction manager module registered with user interaction manager 114. Device 102 may include a windows-based user interaction model, a WAP-based user interaction model, a television-based user interaction model, an automobile display user interaction model, a projector user interaction model, a PDA-based user interaction model (such as a BLACKBERRY® user interaction model), a command line user interaction model, and the like. A user interaction model may be installed and registered in a manner similar to device handlers and may be packaged along with specific drivers. User interaction manager 114 may determine which user interaction model to used by mapping a detected display characteristic or input interface characteristic to a user interaction model using a lookup table listing user interaction models and corresponding display and input interface characteristics. The lookup table may be stored in a database 134. If a match is found in the lookup table, the user interaction model may be applied for interfacing with the display or input interface. If an exact match is not found in the lookup table, user interaction manager 114 may select a close match to use for interfacing or provide a user with an option of selecting a user interaction model from the lookup table.

One or more applications may reside on or be accessible by device 102. For example, device 102 may include applications 118, 120, and 122. An application may provide instructions for interacting with display 104 and/or input interface 106. User interaction models 128, 130, and 132 may be used for interfacing applications 118, 120, and 122 with display 104 and/or input interface 106. For example, applications 118 and 122 may use user interaction models 128 and 132, respectively, for interacting with display 104 and input interface 106. One display 104 and one input interface 106 may map to one user interaction model 128, 130, or 132; so applications 118, 120, and 122 may use the system selected used interaction model 128, 130, or 132. Further, an application may interface with more than one user interaction model for interacting with a display and/or input interface. For example, application 120 may use user interaction models 128,130, and 132 for interacting with display 104 and input interface 106. Typically, an application may use a user interaction model 128, 130, or 132 that matches one or more characteristics of a given display 104 and input interface 106.

Applications 118, 120, and 122 may include user interaction clients 136 for driving user interaction models. For example, assuming user interaction model 128 is a windows-based user interaction model, user interaction client 136 of application 118 may include functionality for driving a windows interface environment displayed via display 104.

System 100 includes means for receiving an indication to use one of a display and an input interface usable by a device. For example, user interaction manager 114 may receive an indication to use display 104 and/or input interface 106. Input event handler 116 may detect one or more input interfaces connected to device 102 and indicate a connection to an input interface to user interaction manager 114. Further, input interface drivers 126 may detect input and notify system components, such as manager 114, through events. User interaction manager 114 may register one or more drivers 126 to detect available input interfaces and the events which drivers 126 detect.

In one example, user interaction manager 114 may receive an indication to use display 104 from display controller 110. Display controller 110 may detect one or more displays connected to device 102 and indicate a connection to a display to user interaction manager 114. Further, display drivers 124 may detect display activity and notify system components, such as manager 114, through events. User interaction manager 114 may register one or more drivers 124 to detect available displays and the events which drivers 126 detect.

System 100 may include means for detecting a characteristic of a display and/or input interface. For example, user interaction manager 114 may detect characteristics of displays and input interfaces. As stated above, each display driver 124 may be operable to provide display controller 110 with characteristics of the display being driven. Further, as stated above, each input interface 126 may be able to provide input interface controller 112 with characteristics of the input interface being driven.

System 100 may include means for determining a user interaction model from a plurality of user interaction models based on a characteristic of a display and/or input interface. For example, as stated above, user interaction manager 114 may determine which user interaction model to use by mapping a detected display characteristic or input interface characteristic to a lookup table listing user interaction models. In another example, if an exact match is not found in the lookup table, user interaction manager 114 may select a close match to use for interfacing or provide a user with an option of selecting a user interaction model from the lookup table, or user interaction manager 114 may ask a user to select a user interaction model 128, 130, or 132 where the user is provided with or has knowledge of a display characteristic and/or an input interface characteristic. User interaction manager 114 may store user selections in database 134 for future automatic mapping operations.

System 100 may include means for activating a user interaction model for use with a display and/or input interface. For example, user interaction manager 114 may communicate commands to user interaction models 128, 130, and 132 for activating the user interaction models. The activated user interaction model may be the model selected from a plurality of user interaction models based on a characteristic of a display and/or input interface.

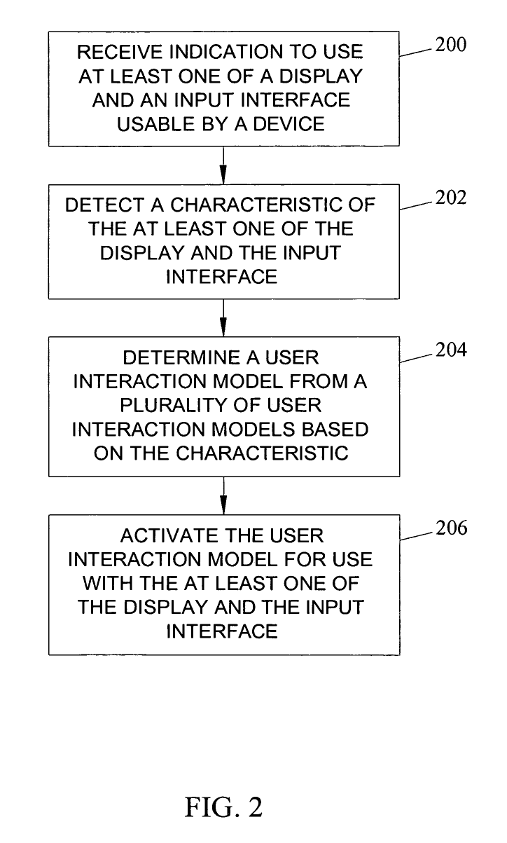

FIG. 2 is a flow chart illustrating an exemplary process for providing a user interaction model for use by a device to match the capabilities of a display connected to the device or an input interface used by the device according to an embodiment of the subject matter described herein. Referring to FIG. 2, in block 200 an indication to use at least one of a display and an input interface usable by a device is received. In block 202, a characteristic of the at least one of the display and the input interface is detected. A user interaction model from a plurality of user interaction models is determined based on the characteristic in block 204. In block 206, the user interaction model may be activated for use with the at least one of the display and the input interface.

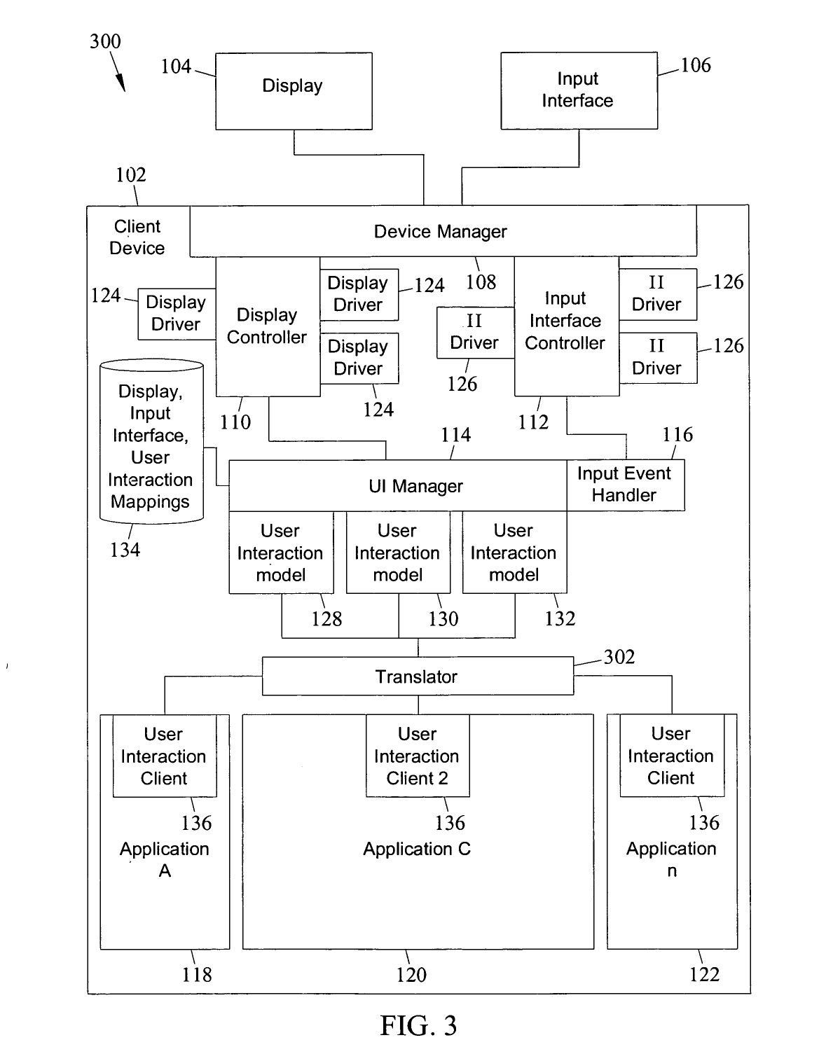

FIG. 3 is a block diagram of another exemplary system 300 for providing a user interaction model for use by a device to match the capabilities of a display connected to the device or an input interface used by the device according to an embodiment of the subject matter described herein. System 300 is similar to system 100 shown in FIG. 1 except that system 300 includes a translator module 302 for providing a translation function between user interaction clients 136 and user interaction models 128, 130, and 132. Translator module 302 is configured to convert the user interaction model supported by a client application into another user interaction model currently in use by user interaction manager 114, if needed. As a result, applications are not required to include code to support multiple user interaction models, thus simplifying application design.

In one example, a word processing application may be designed to receive input from a user via a mobile phone keypad. When the mobile phone is connected to an external keyboard, translator 302 may translate between the keypad I/O expected by the application and the external keyboard I/O by use of a user interaction model. One method for implementing a translator involves the use of eXtensible Stylesheet Language (XSL) for defining XML document transformation and presentation. Since most of the current declarative user interface specification languages are XML variants, one skilled in the art may create extensible Stylesheet Language Transformation (XSLT) documents that define conversion rules for one XML declarative user interface language into another. If user interfaces models are supported by code without the use of declarative user interface languages, then code translators may be written using software to translate a specific user interaction model into another and may require custom code for some applications.

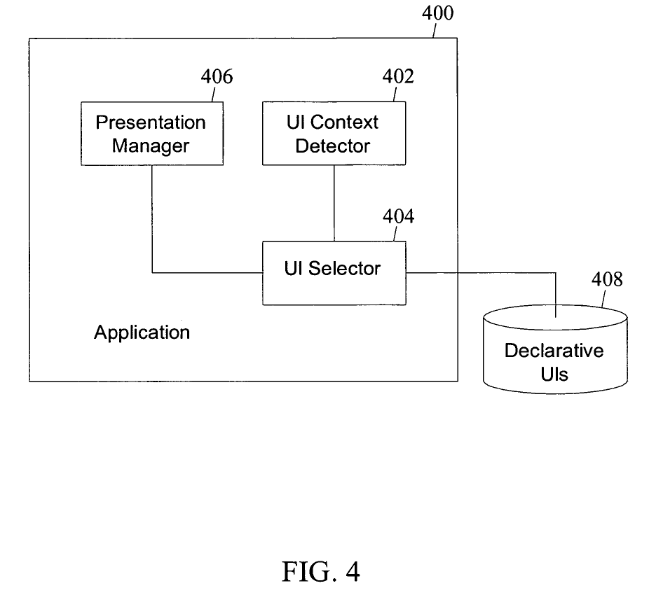

FIG. 4 illustrates a block diagram of an exemplary application 400 according to the subject matter described herein. Application 400 may reside on a device, such as device 102. Referring to FIG. 4, application 400 may include a user interaction context detector 402 operable to determine a user interaction model that functions with application 400. Context detector 402 may also determine a preferred user interaction model from among several user interaction models that are suitable for functioning with application 400.

Application 400 may include one or more files which use a declarative user interface language (e.g., XUL) to define its user interface. These files may contain a script for defining its user interface. For example, JavaScript may enable dynamic features. Further, device 102 may include one or more user interaction models using a number of declarative user interface languages. Application 400 may also include code for driving a user interface library.

Context detector 402 may interact with a user interface selector 404 for selecting a user interaction model file set that is compatible with a display and input interface capabilities from the user interaction models that are supportable and allowed. The files of a selected user interaction model may be provided to a presentation manager 406. Manager 406 may direct the flow of presentation based on detected input events and a state of application 400. Manager 406 may not directly interact with a display, but user interaction declarative files may be passed from a database 408 to manager 406. At manager 406, the user interaction declarative files may be communicated to a matching user interaction model for parsing and presentation. Alternatively, presentation manager 406 may load or invoke a software library that supports the selected user interaction model, rather than or in addition to using files written using a declarative user interface language.

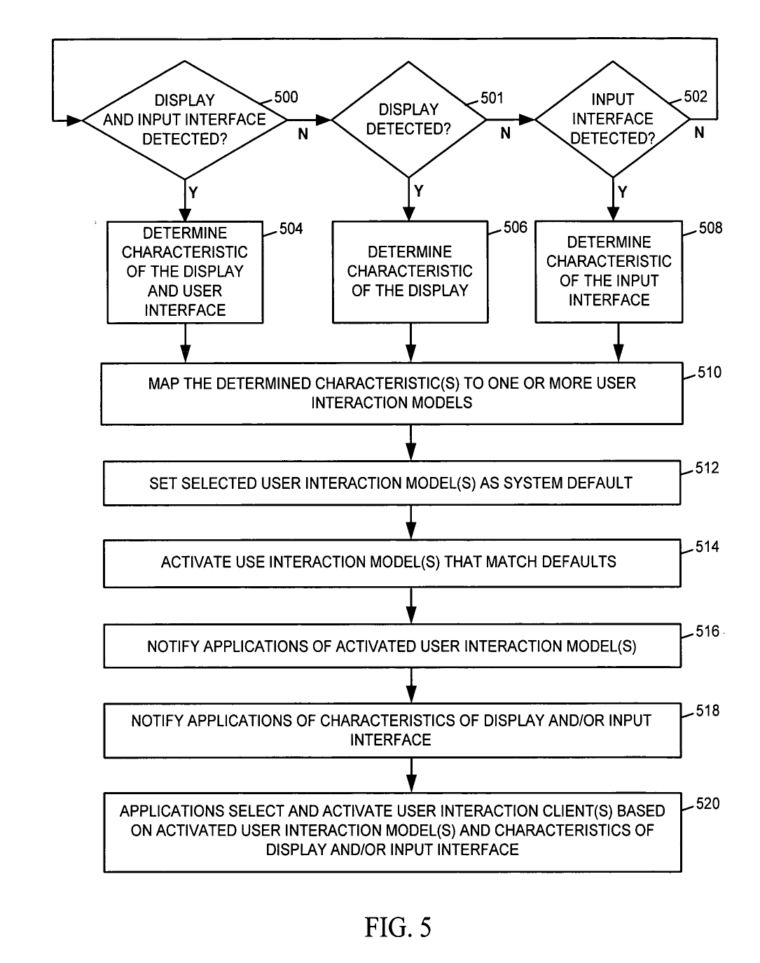

FIG. 5 is a flow chart illustrating an exemplary process for providing a user interaction model for use by device 100 shown in FIG. 1 to match the capabilities of display 104 connected to the device and/or input interface 106 used by the device according to an embodiment of the subject matter described herein. Referring to FIG. 5, user interaction manager 114 may detect display 104, input interface 106, or both in blocks 500-502. In blocks 504, 506, or 508, manager 114 may determine one or more characteristics of display 104 and/or input interface 106, depending on which components are detected in blocks 500-502.

At block 510, user interaction manager 114 may map characteristics determined in blocks 504, 506, or 508 to one or more user interaction models. The lookup table in database 134 may be used for mapping. The display characteristics may be mapped to a user interaction model that is the best available model for the display characteristics and/or user input characteristics detected. When both display 104 and input interface 106 are detected, a single user interaction model can be retrieved from the lookup table that is common to both, or at least compatible with both. The lookup table can include information for cross referencing each interaction model to both displays 104 and input interfaces 106 based on compatibility. Alternatively, a separate user interface for each of display 104 and input interface 106 can be retrieved from the lookup table. In any case, when a match is found in the lookup table, the user interaction model may be applied for interfacing with the display or input interface. If an exact match is not found in the lookup table, user interaction manager 114 may select a close match to use for interfacing or provide a user with an option of selecting a user interaction model.

At block 512, the user interaction model(s) selected may be set as system defaults for display 104 and input interface 106. The default information may be stored at user interaction manager 114.

At block 514, manager 114 activates the user interaction models that are indicated by the default for use with display 104 and input interface 106. For example, user interaction model 128 may be indicated as a default for display 104 and activated for use with display 104. In another example, user interaction model 132 may be indicated as a default for input interface 106 and activated for use with input interface 106. In yet another example, user interaction model 130 may be indicated as a default when both input interface 106 and display 104 are detected.

At block 516, manager 114 may notify applications 118,120, and 122 of the activated user interaction models for use with display 104 and/or input interface 106. For example, applications 118 and 120 may be notified of activated user interaction models 128 and 130 for use with display 104 and input interface 106. Further, for example, applications 120 and 122 may be notified of activated user interaction models 128 and 130 for use with display 104 and input interface 106.

Manager 114 may notify applications of characteristics of display 104 and input interface 106 (block 518). For example, applications 118, 120, and 122 may be notified of characteristics of display 104 and input interface 106.

At block 520, applications may select and activate user interaction clients based on activated user interaction models and characteristics of display and/or input interface. For example, user interaction client 136 of application 118 may be selected and activated for driving user interaction model 128. The selected user interaction client may not match the default user interaction model. If the user interaction client does not match, the client may be adapted for driving user interaction model by using the characteristics information provided by manager 114. According to one embodiment, an application may not be allowed to proceed without supporting the system-selected user interaction model. In such a case, an application must either support the model, terminate, or run without user interaction.

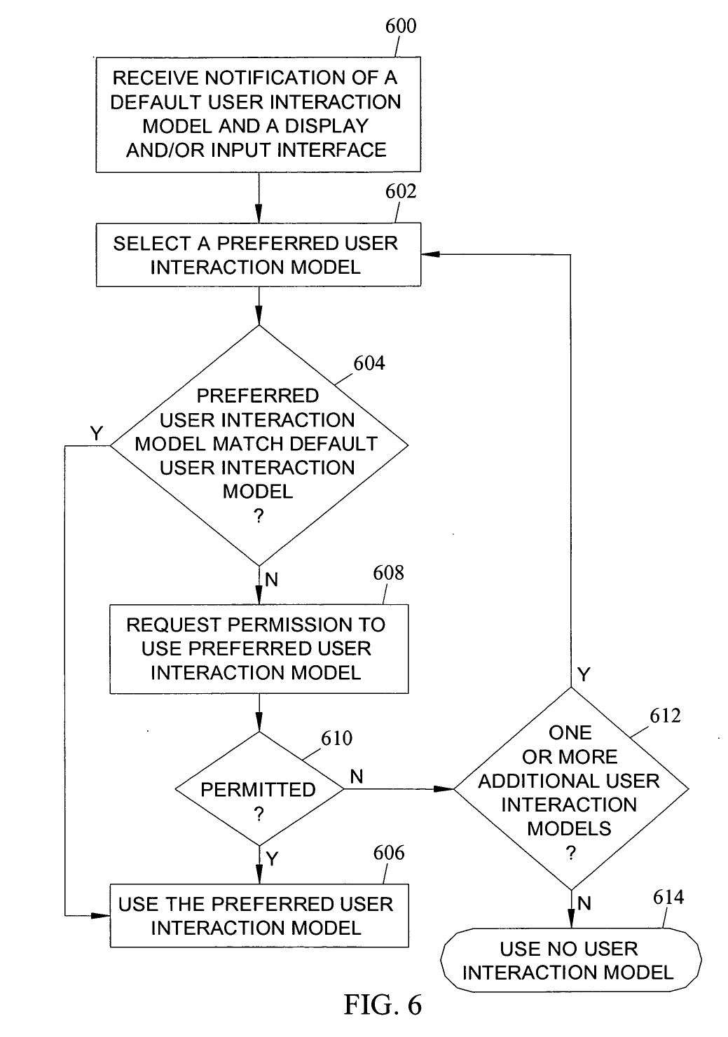

FIG. 6 is a flow chart illustrating an exemplary process for use by application 400 shown in FIG. 4 for selecting a user interaction model according to an embodiment of the subject matter described herein. Referring to FIG. 6, application 400 may receive notification of a default user interaction model for use with a display and/or input interface (block 600). At block 602, user interface context detector 402 may select a preferred user interaction model from among a plurality of user interaction models that are each compatible with the display and/or the input interface. Application 400 may determine whether the application is compatible with the user interaction models.

At block 604, user interface selector 404 may determine whether the preferred user interaction model matches the default user interaction model. If the preferred user interaction model matches the default user interaction model, application 400 may use the default user interaction model for interacting with the display and/or the input interface (block 606). Otherwise, if the preferred user interaction model does not match the default user interaction model, application 400 may request permission from a user interaction manager 114 to activate the preferred user interaction model (block 608).

At block 610, application 400 may determine whether use of the preferred user interaction model is permitted. If permitted, the preferred user interaction model may be activated at block 606. Otherwise, if not permitted, application 400 may determine there is one or more other user interaction models that are each compatible with the display 104 and/or the input interface 106 (block 612). If there is one or more other user interaction models, then a preferred user interaction model from among these models may be selected at block 602, the process may proceed to block 604 and use this next model as the preferred model. If there are no other user interaction models, then no user interaction model is activated (block 614). In an alternate embodiment, the application may use the default model, if supported by the application. Further, if a user interaction model is not compatible with application 400, application 400 may be disabled or the user interaction manager may allow application 400 to run using a user interaction model which is not preferred or perform a translation from the application's preferred user interaction model to another user interaction model.

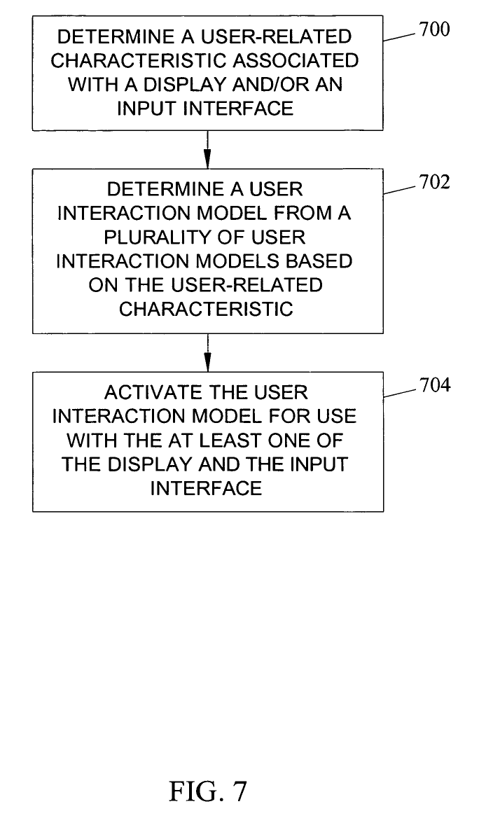

According to another aspect of the subject matter described herein, a user-related characteristic may be used for determining a user interaction model for use by a device. For example, it may be desirable to select a user interaction model based on user characteristics, such as the number of users that are viewing a display device. FIG. 7 is a flow chart illustrating a process for using a user-related characteristic for determining a user interaction model for use by device 102 shown in FIG. 1 according to an embodiment of the subject matter described herein. Referring to FIG. 7, device 102 may determine a user-related characteristic associated with a detected display 104 and/or an input interface 106 (block 700). For example, device 102 may determine a number of viewers of display 104. In another example, device 102 may determine a distance of one or more viewers from display 104. In another example, device 102 may determine an average distance of viewers from display 104. In another example, device 102 may determine a range of distances between device 102 and one or more users. The distance of the viewers may be detected via sensors associated with display 104 or provided to display 104. In an alternate embodiment, instead of or in addition to determining a user characteristic, device 102 may be provided a user characteristic. At block 702, a user interaction model may be determined from a plurality of user interaction models based on the user-related characteristic. Further, at block 704, the user interaction model may be activated for use with the at least one of the display and the input interface.

### User Interaction Model Examples

According to one embodiment, a user interface navigation of an input interface may be altered in accordance with an activated user interaction model. A handheld electronic device, such as a mobile phone, a digital camera, or PDA, according to the subject matter described herein, may include a built-in display and the capability to connect to a plurality of external displays. The device is enabled to support display drivers for the built-in display and one or more of the external displays. In normal use, the device may only use the built-in display. In these instances, a mobile phone, for example, may include a WAP user interaction model for use with the built-in display. For example, a WAP user interaction model may include a 4-way controller, a select button, two soft keys, and a phone key alphanumeric keypad. In this example, the WAP-enabled phone uses a device to access a desktop PC using the PC's remote desktop facility. The phone provides the display and the input interface for the PC. The desktop PC may support a remote desktop feature, such as VNC or MICROSOFT WINDOWS DESKTOP™. The PC detects an active remote desktop request and receives and/or determines as many characteristics of the accessing device's display and/or input interface as possible. Since the accessing device is a WAP-enabled phone, the user interaction model selected for use on the accessing device is a WAP-like user interaction model that the phone is enabled to support and that the user of the phone is familiar with when using the phone.

In another example, the WAP-enabled phone establishes a connection to an external 42″ HDTV supporting a remote control input device. The phone detects the display size and the remote control user interface support and selects a user interaction model that is TV-like and controllable using the TV's remote control. If the WAP-enabled phone had detected only the display size and not detected any user input characteristic, then the phone may select a user interaction model that is based on the use of the phones input described above, namely relying on two soft keys, a four-way controller, a select key, and a phone keypad which takes advantage of the size of the display allowing more applications and services to be selected and used from the main screen. This results in an interface where the navigation hierarchy is shallower than when using the phone's built-in display.

A device may be operable to host multiple user interaction model libraries providing different user interaction models. A device may be operable to support a WAP-based user interaction model, a windows-based user interaction model, a television-based user interaction model, a car dash-mounted display user interaction model, and a projection user interaction model. The WAP-based user interaction model may use standard WAP input controls. The windows-based user interaction model may be based on X-windows or a MICROSOFT WINDOWS® windows environment. The windows-based user interaction model may include variations, such as being for use with only the input controls provided by the device, being for use with peripherally attached keyboard and pointing device, and being for use with a remote control suitable for a projection device. The remote control suitable for a projection device may include a laser pointer, three buttons analogous to buttons on a 3-button mouse, and keys for forward, back, go to start, and go to end. A projection user interaction model may be suitable for presentation to others and controllable via a keyboard, mouse, and/or projector remote control. It is expected that new user interaction models combining presentation aspects from existing user interaction models with user input models from other user interaction models, and totally new user interaction models will be created for display and user input combinations that are not possible today. For example, a desktop PC with a 19″ display and a TV remote as the input interface may yield a new user interaction model or may simply result in a combination of a window-based display with remote control style navigation and selection with special provisions for difficult tasks with the remote control, such as text input.

According to one embodiment, a user interaction manager may receive or identify an input file for indicating a display and/or input interface for a device to use. Exemplary input files include an XML file, an XUL file, an XAML file, and an XHTML file. A specific user interaction model may be described using a declarative user interaction language. The files may be made dynamic because they may support embedded scripts and external script libraries. The user interaction manager may detect the type of file and invoke a content handler that is able to parse and display the user interaction model as directed by the file. A script engine that matches the scripting language may be invoked to make the display dynamic, if scripts are embedded.

The following is an example of operation of the subject matter described herein in providing a user interaction model for use by a device to match the capabilities of a display connected to the device or an input interface used by the device.
1. A user has a presentation stored on a PDA. The user has been reviewing the presentation on the PDA's default display. The user determines that the presentation contains important information that the user's coworkers should see immediately.
2. The user connects the PDA to a 52″ HDTV in a meeting room for showing the presentation to the coworkers. In response to the connection, the PDA detects the new active HDTV and requests display characteristics from the HDTV.
3. The PDA retrieves display characteristics from the HDTV such as a display size, supported colors, and display resolution.
4. The PDA may prompt the user to indicate one or more input interfaces that are to be supported. Alternatively, the PDA may automatically detect at least a portion of one or more input interfaces.
5. The user may use the remote control for the HDTV to navigate through the presentation presented on the HDTV.
6. The PDA may determine that it should use a TV-based user interaction model for allowing the user to activate a menu through the remote control menu button, to navigate using the directional buttons, and to control the sound through the remote control's volume controls. The remote selection button may allow the user to activate items which have been navigated within.
7. The PDA may inform active applications that a switch to the TV-based user interaction model is going to occur. The application may accept the recommendation and switch models. The application may support the default display and the HDTV display at the same time by using a different user interaction model for each.
8. The PDA may send the display to the HDTV.
9. The user may press the remote control's menu key to view a list of active applications (or may use the change channel key to cycle through the active applications) and select the presentation. Further, the user may press the menu key and select maximize. The menu that is displayed may depend on the application and pane that have focus. In other words, in this user interaction model, the menu button on the HDTV remote may bring up a context menu.
10. The user may use navigation keys of the remote control to navigate through the presentation.

It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

What is claimed is:

1. A method for providing a user interaction model for use by a device to match the capabilities of a display connected to the device or an input interface used by the device, the method comprising:
receiving an indication to use at least one of a display and an input interface usable by a device;
detecting a characteristic of the at least one of the display and the input interface;
determining a user interaction model from a plurality of user interaction models based on the characteristic; and
activating the user interaction model for use with the at least one of the display and the input interface.

2. The method of claim 1 wherein receiving an indication to use at least one of a display and an input interface includes receiving one of an extended markup language (XML) file, an XML-based user interface language (XUL) file, a transaction authority markup language (XAML) file, and an extensible hypertext markup language (XHTML) file.

3. The method of claim 1 wherein the device includes one of a mobile phone, a digital camera, a personal digital assistant (PDA), and a computer.

4. The method of claim 1 wherein the display includes one of a projector, a television, a monitor, a mobile phone display, a windows model display, and a remote display of a computer system.

5. The method of claim 1 wherein detecting a characteristic of the at least one of the display and the input interface includes detecting at least one of a size of the display, a resolution of the display, colors supported by the display, a number of colors supported by the display, a dot pitch of the display, a video format, and a display standard.

6. The method claim 1 wherein determining a user interaction model includes determining a user interaction model from among a windows-based user interaction model, a wireless application protocol (WAP)-based user interaction model, a television-based user interaction model, an automobile display user interaction model, a projector user interaction model, a personal digital assistant (PDA)-based user interaction model, and a command line user interaction model.

7. The method of claim 1 comprising determining an application characteristic of an application used by the device and wherein determining a user interaction model includes determining the user interaction model from the plurality of user interaction models based on the application characteristic of the application.

8. The method of claim 7 wherein determining the user interaction model from the plurality of user interaction models based on the application characteristic of the application includes determining whether the application is compatible with one of the plurality of user interaction models.

9. The method of claim 8 wherein activating the user interaction model includes activating a user interaction model compatible with the application.

10. The method of claim 1 comprising determining a user-related characteristic of one or more users of the device and wherein determining a user interaction model includes determining the user interaction model from the plurality of user interaction models based on the user-related characteristic.

11. The method of claim 10 wherein the user-related characteristic comprises at least one of a number of the one or more users of the device, a distance between the device and the one or more users of the device, an average distance between the device and the one or more users of the device, and a range of distances between the device and the one or more users.

12. The method of claim 1 comprising altering user interface navigation of the input interface the device in accordance with the activated user interaction model.

13. The method of claim 1 comprising communicating display information to the display in accordance with the activated user interaction model.

14. A system for providing a user interaction model for use by a device to match the capabilities of a display connected to the device or an input interface used by the device, the system comprising:
a plurality of user interaction models that are each operable to match capabilities of a device with a display connected to the device or an input interface used by the device; and
a user interaction manager operable to:
receive an indication to use at least one of the display and the input interface usable by the device;
detect a characteristic of the at least one of the display and the input interface;
determine a user interaction model from the plurality of user interaction models based on the characteristic; and
activate the user interaction model for use with the at least one of the display and the input interface.

15. The system of claim 14 wherein the user interaction manager is operable to receive one of an extended markup language (XML) file, an XML-based user interface language (XUL) file, a transaction authority markup language (XAML) file, and an extensible hypertext markup language (XHTML) file for indicating to use at least one of the display and the input interface usable by the device.

16. The system of claim 14 wherein the device comprises at least one of a mobile phone, a digital camera, a personal digital assistant (PDA), and a computer.

17. The system of claim 14 wherein each of the user interaction models is operable to match capabilities of the device with one of a projector, a television, a monitor, a mobile phone display, a windows model display, and a remote display of a computer system.

18. The system of claim 14 wherein the user interaction manager is operable to detect at least one of a size of the display, a resolution of the display, colors supported by the display, a number of colors supported by the display, a dot pitch of the display, a video format, and a display standard.

19. The system claim 14 wherein the plurality of user interaction models includes at least one of a windows-based user interaction model, a wireless application protocol (WAP)-based user interaction model, a television-based user interaction model, an automobile display user interaction model, and a projector user interaction model, a personal digital assistant (PDA)-based user interaction model, and a command line user interaction model.

20. The system of claim 14 wherein the user interaction manager is operable to determine the user interaction model from the plurality of user interaction models based on a characteristic of an application executing on the device.

21. The system of claim 20 wherein the user interaction manager is operable to determine whether the application is compatible with one of the plurality of user interaction models.

22. The system of claim 21 wherein the user interaction manager is operable to activate a user interaction model compatible with the application.

23. The system of claim 14 wherein the user interaction manager is operable to determine a user-related characteristic of one or more users of the device and wherein determining a user interaction model includes determining the user interaction model from the plurality of user interaction models based on the user-related characteristic.

24. The system of claim 23 wherein the user-related characteristic includes at least one of a number of the one or more users of the device, a distance between the device and the one or more users of the device, an average distance between the device and the one or more users of the device, and a range of distances between the device and the one or more users.

25. The system of claim 14 wherein the user interaction manager is operable to alter user interface navigation of the input interface the device in accordance with the activated user interaction model.

26. The system of claim 14 wherein the user interaction manager is operable to communicate display information to the display in accordance with the activated user interaction model.

27. A system for providing a user interaction model for use by a device to match the capabilities of a display connected to the device or an input interface used by the device, the system comprising:
means for receiving an indication to use at least one of a display and an input interface usable by a device;
means for detecting a characteristic of the at least one of the display and the input interface;
means for determining a user interaction model from a plurality of user interaction models based on the characteristic; and
means for activating the user interaction model for use with the at least one of the display and the input interface.

28. A computer program product comprising computer executable instructions embodied in a computer readable medium for performing steps comprising:
receiving an indication to use at least one of a display and an input interface usable by a device;
detecting a characteristic of the at least one of the display and the input interface;
determining a user interaction model from a plurality of user interaction models based on the characteristic; and
activating the user interaction model for use with the at least one of the display and the input interface.
